(19) United States
(12) Patent Application Publication
(10) Pub. No.: US 2010/0017807 A1
(43) Pub. Date: Jan. 21, 2010

(54) SYSTEM, METHOD, AND COMPUTER PROGRAM PRODUCT FOR TRANSPARENT COMMUNICATION BETWEEN A STORAGE DEVICE AND AN APPLICATION

(76) Inventor: Radoslav Danilak, Cupertino, CA (US)

Correspondence Address: Zilka-Kotab, PC, P.O. BOX 721120, SAN JOSE, CA, 95172-1120, US

(21) Appl. No.: 12/173,643

(22) Filed: Jul. 15, 2008

(51) Int. Cl. G06F 3/00

(52) U.S. Cl. 719/313

(57) ABSTRACT

A system, method, and computer program product are provided for modulating a response time of a response to an application for communicating with the application. In operation, data from an application is received. Additionally, the application is identified based on the data. Further, a response time of a response to the application is modulated for communicating with the application.

### FIELD OF THE INVENTION

The present invention relates to computer devices and more particularly to interfacing hardware of such devices to software applications.

### BACKGROUND

In some cases, it is desirable for a software application on a computer system to communicate directly with a storage device. In general, for a software application to communicate directly with a storage device, disk protocols, disk controllers, device drivers or operating systems must be modified. These modifications are extremely cumbersome. There is thus a need for addressing these and/or other issues associated with the prior art.

### SUMMARY

A system, method, and computer program product are provided for modulating a response time of a response to an application for communicating with the application. In operation, data from an application is received. Additionally, the application is identified based on the data. Further, a response time of a response to the application is modulated for communicating with the application.

### BRIEF DESCRIPTION OF THE DRAWINGS

FIG. 1 shows a method for modulating a response time of a response to an application for communicating with the application, in accordance with one embodiment.

FIG. 2 shows a system for transparent communication between a storage device and an application, in accordance with one embodiment.

FIG. 3 shows a method for modulating a response time of a response to an application for communicating with the application, in accordance with another embodiment.

FIG. 4 shows a method for communicating between a storage device and an application, in accordance with one embodiment.

FIG. 5 illustrates an exemplary system in which the various architecture and/or functionality of the various previous embodiments may be implemented.

### DETAILED DESCRIPTION

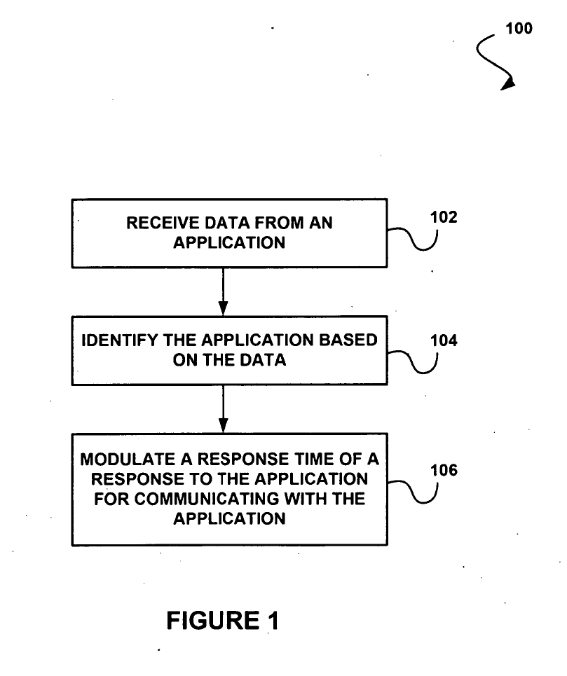

FIG. 1 shows a method 100 for modulating a response time of a response to an application for communicating with the application, in accordance with one embodiment. As shown, data from an application is received. See operation 102.

In this case, the data may include any type of data. Furthermore, in the context of the present description, an application refers to any type of software application. For example, in various embodiments, the application may include a word processing application, a security application, a spreadsheet application, and/or any other type of application.

Additionally, the application is identified based on the data. See operation 104. Further, a response time of a response to the application is modulated for communicating with the application. See operation 106.

In one embodiment, the receiving, the identifying, and the modulating may be performed by a storage device. In the context of the present description, a storage device refers to any device capable of storage. For example, in various embodiments, the storage device may include a mechanical storage device (e.g. a disk drive including a SATA disk drive, a SAS disk drive, a fiber channel disk drive, an IDE disk drive, an ATA disk drive, a CE disk drive, a USB disk drive, a smart card disk drive, an MMC disk drive, etc.) and/or a non-mechanical storage device (e.g. semiconductor-based, etc.). In various embodiments, the non-mechanical storage device may include flash memory, such as single-bit per cell NOR flash memory, multi-bit per cell NOR flash memory, single-bit per cell NAND flash memory, multi-bit per cell NAND flash memory, multi-level-multi-bit per cell NAND flash, or large block flash memory, etc.

As an option, the application may be executed by a host in communication with the storage device. In the context of the present description, a host refers to any device capable of hosting a storage device. For example, in various embodiments, the host may include, but is not limited to, a desktop computer, a laptop computer, a handheld computer, a personal digital assistant (PDA) device, a mobile phone, and/or any other computing device that meets the above definition.

More illustrative information will now be set forth regarding various optional architectures and features with which the foregoing framework may or may not be implemented, per the desires of the user. It should be strongly noted that the following information is set forth for illustrative purposes and should not be construed as limiting in any manner. Any of the following features may be optionally incorporated with or without the exclusion of other features described.

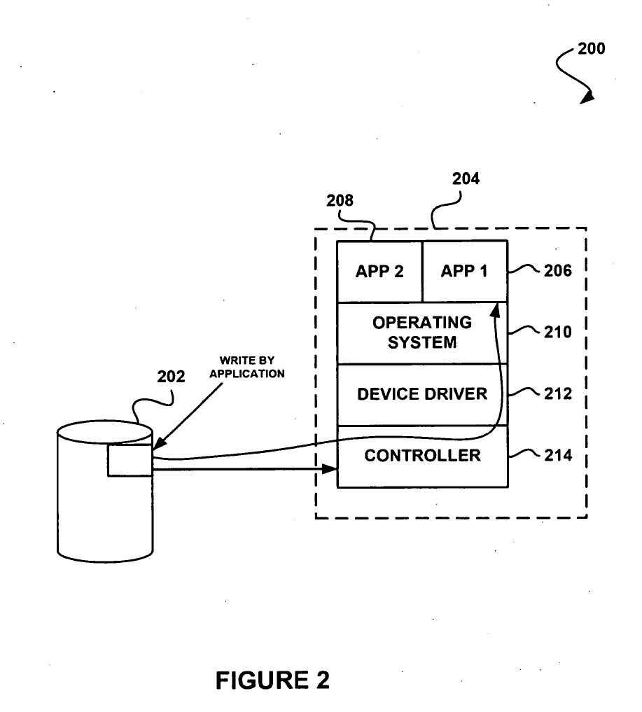

FIG. 2 shows a system 200 for transparent communication between a storage device and an application, in accordance with one embodiment. As an option, the present system 200 may be implemented to carry out the method 100 of FIG. 1. Of course, however, the system 200 may be implemented in any desired environment. It should also be noted that the aforementioned definitions may apply during the present description.

As shown, a storage device 202 is provided. Furthermore, a host system 204 is provided. In this case, the host system 204 includes at least one application 206-208, an operating system 210, at least one device driver 212, and a memory controller 214.

In operation, data from at least one of the applications 206-208 is received by the storage device 202. Using this data, the application that sent the data is identified. In one embodiment, the application 206-208 may be identified utilizing a key in association with the data.

In this case, the key may be any unique key used to identify an application. In one embodiment, the key may accompany the data. As an option, the key may be appended to the data in a header. As another option, the key may be appended to the end of the data.

Additionally, the data may be encrypted. In this case, the data may include a cryptographic signature. It should be noted that any suitable encryption technique may be utilized.

In one embodiment, a response time of a response to the application 206-208 may be modulated for communicating with the application 206-208. As an option, the response time of the response to the application 206-208 may be modulated to communicate information to the application 206-208. In this case, the information may relate to the data received from the application 206-208. Furthermore, the information may be encoded in the modulation of the response time.

In another embodiment, the storage device 202 may send information requested by the application to the application 206-208. Further, the information may include a response to the application 206-208. In this case, the information may relate to the data received from the application 206-208.

As an option, the information may be encoded. For example, the information may be encoded using an encoding/encryption device. In one embodiment, the encoding of the information may correspond to a key used to identify the application. In this way, the application which sent the data may have the ability to utilize the encoded information.

Additionally, the communication with the application may be transparent to the operating system 210 of the host 204 on which the application 206-208 is executed. The operating system 210 may include any number of operating systems. For example, in various embodiments, the operating system may include a Windows, Linux, or other suitable operating system.

Using the system 200, transparent communication between applications and storage devices may be implemented. As an option, a response time of the operating system 210 may be modulated. For example, one of the applications 206-208 may write in data pattern recognized by the storage device 202. The storage device 202 may recognize the pattern and modulate response time, thus communicating information.

As another option, the application 206-208 may modulate request times and change patterns to communicate to the storage device 202. Thus, two way communications between applications and storage devices may be implemented without modifying operating systems or host bus adapters.

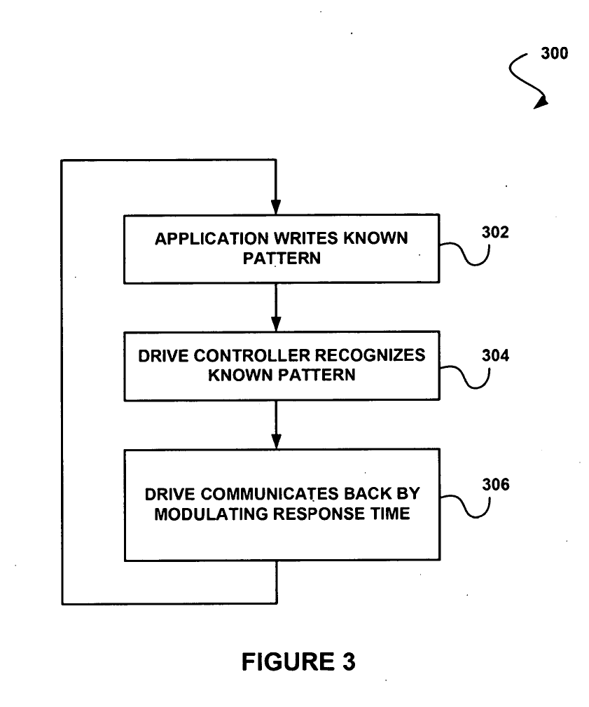

FIG. 3 shows a method 300, for modulating a response time of a response to an application for communicating with the application, in accordance with another embodiment. As an option, the present method 300 may be implemented in the context of the functionality and architecture of FIGS. 1-2. Of course, however, the method 300 may be carried out in any desired environment. Again, the aforementioned definitions may apply during the present description.

As shown, an application writes a known data pattern. See operation 302. In this case, the known pattern may include any known pattern. In one embodiment, the known pattern may be a pattern unique to the application.

Once the application writes the known pattern, a drive controller recognizes the known pattern. See operation 304. In this case, the drive controller may recognize the known pattern by comparing the pattern against one of a plurality of known patterns. As another option, the drive controller may recognize the known pattern by comparing the pattern against a key.

The drive then communicates back by modulating a response time of a response to the application. See operation 306. In this case, modulating a response time of the response refers to varying a time of the response or a signal including such response. For example, the phase of a signal including the response may be varied. As an option, the drive controller may modulate the response time of the response to the application.

Further, in the context of the present description, a drive refers to any device capable of storing data. For example, in various embodiments, the drive may include, but is not limited to, a hard disk drive (removable or internal), flash memory (e.g. a USB stick, etc.), and/or any other type of storage device. Once the drive communicates the response, the application may again write a known pattern to be recognized.

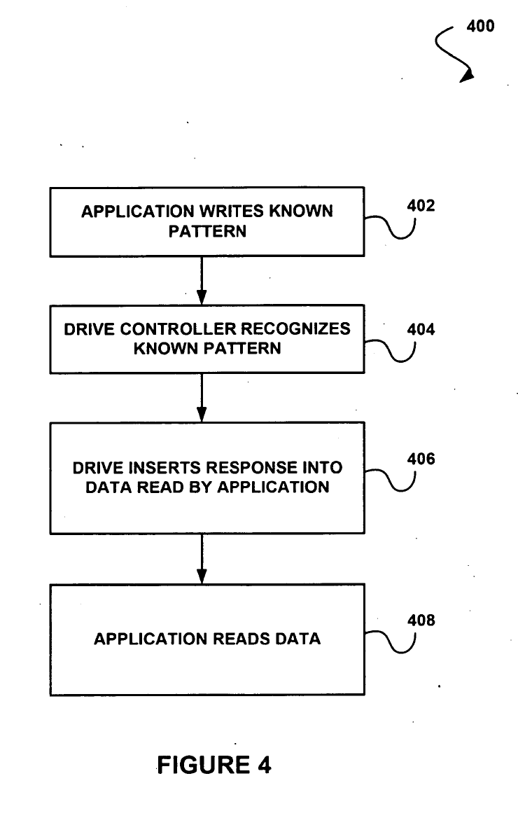

FIG. 4 shows a method 400 for communicating between a storage device and an application, in accordance with one embodiment. As an option, the present method 400 may be implemented in the context of the functionality and architecture of FIGS. 1-3. Of course, however, the method 400 may be carried out in any desired environment. Further, the aforementioned definitions may apply during the present description.

As shown, an application writes a known pattern. See operation 402. In this case, the known pattern may include any known pattern. For example, in various embodiments, the known pattern may include a unique key or signature. In one embodiment, the known pattern may be a pattern included in data supplied by the application.

Once the application writes the known pattern, a drive controller recognizes the known pattern. See operation 404. In this case, the drive controller may recognize the known pattern by comparing the pattern against one of a plurality of known patterns. As another option, the drive controller may recognize the known pattern by comparing the pattern against a key.

Once the drive controller recognizes the known pattern, the drive inserts a response into data to be read by the application. See operation 406. In this case, the drive may insert the response in the same location as the data. As an option, the response may be included as part of a header or footer to the data. As another option, the response may be embedded in the data.

The data, including the response, may then be sent to the application such that the application may then read the data. See operation 408. Thus, the application may utilize the data and/or information included as part of the response.

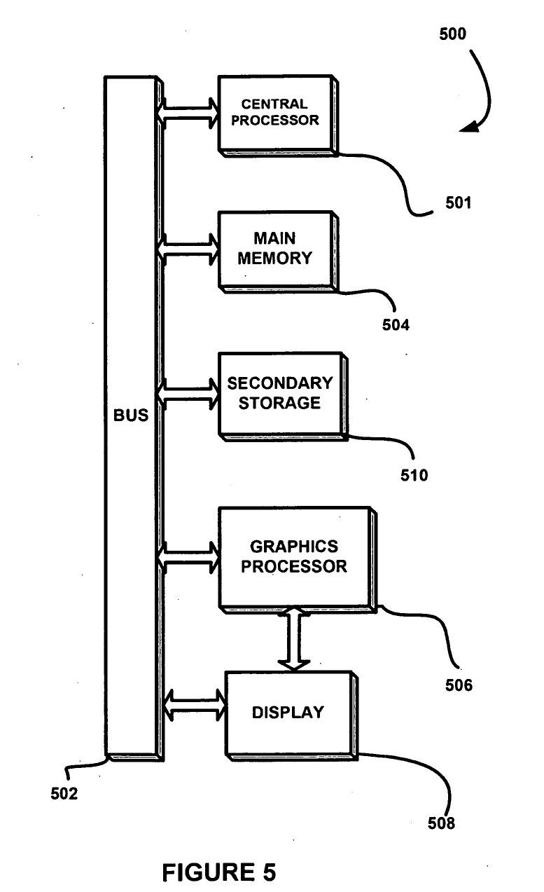

FIG. 5 illustrates an exemplary system 500 in which the various architecture and/or functionality of the various previous embodiments may be implemented. As shown, a system 500 is provided including at least one host processor 501 which is connected to a communication bus 502. The system 500 also includes a main memory 504. Control logic (software) and data are stored in the main memory 504 which may take the form of random access memory (RAM).

The system 500 also includes a graphics processor 506 and a display 508, i.e. a computer monitor. In one embodiment, the graphics processor 506 may include a plurality of shader modules, a rasterization module, etc. Each of the foregoing modules may even be situated on a single semiconductor platform to form a graphics processing unit (GPU).

In the present description, a single semiconductor platform may refer to a sole unitary semiconductor-based integrated circuit or chip. It should be noted that the term single semiconductor platform may also refer to multi-chip modules with increased connectivity which simulate on-chip operation, and make substantial improvements over utilizing a conventional central processing unit (CPU) and bus implementation. Of course, the various modules may also be situated separately or in various combinations of semiconductor platforms per the desires of the user.

The system 500 may also include a secondary storage 510. The secondary storage 510 includes, for example, a hard disk drive and/or a removable storage drive, representing a floppy disk drive, a magnetic tape drive, a compact disk drive, etc. The removable storage drive reads from and/or writes to a removable storage unit in a well known manner.

Computer programs, or computer control logic algorithms, may be stored in the main memory 504 and/or the secondary storage 510. Such computer programs, when executed, enable the system 500 to perform various functions. Memory 504, storage 510 and/or any other storage are possible examples of computer-readable media.

In one embodiment, the architecture and/or functionality of the various previous figures may be implemented in the context of the host processor 501, graphics processor 506, an integrated circuit (not shown) that is capable of at least a portion of the capabilities of both the host processor 501 and the graphics processor 506, a chipset (i.e. a group of integrated circuits designed to work and sold as a unit for performing related functions, etc.), and/or any other integrated circuit for that matter.

Still yet, the architecture and/or functionality of the various previous figures may be implemented in the context of a general computer system, a circuit board system, a game console system dedicated for entertainment purposes, an application-specific system, and/or any other desired system. For example, the system 500 may take the form of a desktop computer, lap-top computer, and/or any other type of logic. Still yet, the system 500 may take the form of various other devices including, but not limited to, a PDA device, a mobile phone device, a television, etc.

Further, while not shown, the system 500 may be coupled to a network [e.g. a telecommunications network, local area network (LAN), wireless network, wide area network (WAN) such as the Internet, peer-to-peer network, cable network, etc.) for communication purposes.

While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

What is claimed is:

1. A method, comprising:
receiving data from an application;
identifying the application based on the data; and
modulating a response time of a response to the application for communicating with the application.

2. The method as set forth in claim 1, wherein the receiving, the identifying, and the modulating are performed by a storage device.

3. The method as set forth in claim 2, wherein the application is executed by a host in communication with the storage device.

4. The method as set forth in claim 1, wherein the application is identified utilizing a key in association with the data.

5. The method as set forth in claim 1, wherein the response time of the response to the application is modulated to communicate information to the application.

6. The method as set forth in claim 5, wherein the information relates to the data received from the application.

7. The method as set forth in claim 5, wherein the information is encoded in the modulation of the response time.

8. The method as set forth in claim 1, wherein the communication is transparent to an operating system of a host on which the application is executed.

9. A method, comprising:
receiving data from an application;
identifying the application based on the data; and
sending information requested by the application to the application, the information including a response to the application.

10. The method as set forth in claim 9, wherein the receiving, the identifying, and the sending are performed by a storage device.

11. The method as set forth in claim 10, wherein the application is executed by a host in communication with the storage device.

12. The method as set forth in claim 11, wherein the application is identified utilizing a key in association with the data.

13. The method as set forth in claim 9, wherein the information relates to the data received from the application.

14. The method as set forth in claim 9, wherein the information is encoded.

15. The method as set forth in claim 9, wherein the communication is transparent to an operating system of a host on which the application is executed.

16. A system, comprising:
a storage device for receiving data from an application;
a device controller for identifying the application based on the data and for modulating a response time of a response to the application for communicating with the application.

17. The system as set forth in claim 16, wherein the application is executed by a host in communication with the storage device.

18. The system as set forth in claim 16, wherein the application is identified utilizing a key in association with the data.

19. The system as set forth in claim 16, wherein the response time of the response to the application is modulated to communicate information to the application.

20. A computer program product embodied on a computer readable medium, comprising:
computer code for receiving data from an application;
computer code for identifying the application based on the data; and
computer code for modulating a response time of a response to the application for communicating with the application.
